(19) United States
(12) Patent Application Publication
(10) Pub. No.: US 2005/0166890 A1
(43) Pub. Date: Aug. 4, 2005

(54) Piston/combustion chamber configurations for enhanced ci engine performace

(76) Inventors: David Darin Wickman, Iron Mountain, MI (US); Rolf Deneys Reitz, Madison, WI (US)

Correspondence Address: Craig Fieschko;DeWitt Ross & Stevens, Suite 401, 8000 Excelsior Drive, Madison, WI, 53717-1914, US

(21) Appl. No.: 10/514,001

(22) PCT Filed: May 16, 2003
(86) PCT No.: PCT/US03/15452

Related U.S. Application Data
(60) Provisional application No. 60/387,865, filed on Jun. 11, 2002.

(51) Int. Cl. F02F 3/26

(52) U.S. Cl. 123/276

(57) ABSTRACT

Piston face (104, 204, 304) and combustion chamber (18) designs for use particularly in HSDI (high speed direct injection) diesel engines include an open bowl (108 208, 308) characterized by a large face perimeter region (106, 206, 306) on the piston face (104, 204, 304), and a bowl (18) defined by a first depressed region (112, 212, 312) gently sloping radially inwardly from the face perimeter region (106, 206, 306) and a second depressed region (116, 216, 316) sharply sloping radially inwardly from the first depressed region (112, 212, 312) to the bowl floor (120, 220, 320). Injection is preferably directed towards an intermediate edge which is well-defined between the first and second depressed regions, resulting in portions of the injected fuel plume being directed to both the squish regions and the portion of the bowl situated below the intermediate edge. The designs promote premixed or MK (Modulated Kinetics) combustion, with a concomitant reduction in soot and nitrous oxides (NOx) emissions while maintaining or enhancing brake specific fuel consumption.

### CROSS-REFERENCE TO RELATED APPLICATIONS

This application claims priority under 35 USC §119(e) to U.S. Provisional Patent Application 60/387,865 filed 11 Jun. 2002, the entirety of which is incorporated by reference herein.

### STATEMENT REGARDING FEDERALLY SPONSORED RESEARCH

This invention was made with United States government support awarded by the following agencies:

U.S. Department of Energy (DOE) Grant No. DE-FG04-99AL66269 The United States has certain rights in this invention.

### FIELD OF THE INVENTION

This disclosure concerns an invention relating generally to piston and/or combustion chamber configurations which allow reduction of emissions and fuel consumption in internal combustion engines, and more specifically to piston and/or combustion chamber configurations which provide emissions reduction in compression ignition (CI or diesel) engines.

### BACKGROUND OF THE INVENTION

Common pollutants arising from the use of compression ignition (CI or diesel) internal combustion engines are nitrogen oxides (commonly denoted NOₓ) and particulates (also known simply as “soot”). NOₓ is generally associated with high-temperature engine conditions, and may be reduced by use of measures such as exhaust gas recirculation (EGR), wherein the engine intake air is diluted with relatively inert exhaust gas (generally after cooling the exhaust gas). This reduces the oxygen in the combustion region and obtains a reduction in maximum combustion temperature, thereby deterring NOₓ formation. Particulates include a variety of matter such as elemental carbon, heavy hydrocarbons, hydrated sulfuric acid, and other large molecules, and are generally associated with incomplete combustion. Particulates can be reduced by increasing combustion and/or exhaust temperatures, or by providing more oxygen to promote oxidation of the soot particles. Unfortunately, measures which reduce NOₓ tend to increase particulate emissions, and measures which reduce particulates tend to increase NOₓ emissions, resulting in what is often termed the “soot-NOₓ tradeoff”.

At the time of this writing, the diesel engine industry is facing stringent emissions legislation in the United States, and is struggling to find methods to meet government- imposed NOₓ and soot targets for the years 2002-2004 and even more strict standards to be phased in starting in 2007. One measure under consideration is use of exhaust after-treatment (e.g., particulate traps) for soot emissions control in both heavy-duty truck and automotive diesel engines. However, in order to meet mandated durability standards (e.g., 50,000 to 100,000 miles), the soot trap must be periodically regenerated (the trapped soot must be periodically re-burned). This requires considerable expense and complexity, since typically additional fuel must be mixed and ignited in the exhaust stream in order to oxidize the accumulated particulate deposits.

Apart from studies directed to after-treatment, there has also been intense interest in the more fundamental issue of how to reduce NOₓ and particulates generation from the combustion process and thereby obtain cleaner “engine out” emissions (i.e., emissions directly exiting the engine, prior to exhaust after-treatment or similar measures). Most studies in this area relate to timing the fuel injection, tailoring the injection rate during injection so as to meet desired emissions standards (including the use of split or multiple injections), modifying the mode of injection (e.g, modifying the injection spray pattern), premixing of fuel and air, and shaping combustion chambers.

One promising field of study has related to the so-called premixed or Modulated Kinetics (MK) combustion mode, which is primarily characterized by three events: (1) injection is made at or near top dead center; (2) the ignition delay exceeds the injection duration so that the fuel/air mixture is at least partially premixed prior to combustion; and (3) a leaner-than-usual fuel/air mixture is used. The object is to minimize the diffusion burning which drives standard diesel combustion and emissions formation, wherein oxidant (fuel) is provided to the oxidizer (air) with mixing and combustion occurring simultaneously. In diffusion burning, fuel droplets within an injected spray plume have an outer reaction zone surrounding a fuel core which diminishes in size as it is consumed, and high soot production occurs at the high-temperature, fuel-rich spray core. In contrast, premixed burning thoroughly mixes fuel and air prior to burning, resulting in less soot production and also deterring the high-temperature diffusion flame region which spawns excessive NOx. One difficulty with achieving premixed combustion is the difficulty in controlling all variables needed for its achievement, especially across a wide range of operating speeds and loads.

Combustion chamber geometry is an interesting field of study because it is one of the few variables critical to engine performance that remains forever fixed once it is initially chosen. Additionally, it is one of the few variables that is relatively cost-tolerant: manufacturing one chamber configuration generally does not have significant cost difference from manufacturing a different configuration (barring unusually complex designs). Combustion chamber studies have largely focused on the shape of the piston face since most diesel engines use a flat (or nearly flat) cylinder head opposite the piston face, and it is well known that the geometry of the piston bowl (the depression conventionally formed on the piston face) has a significant influence on the diesel combustion process. However, the optimization of chamber configurations (for enhanced engine performance is often more a matter of art than science. Owing to the number of variables involved in engine performance, and the interaction between these variables, the effect of different chamber configurations is not easily predicted. Nevertheless, some basic trends in chamber design can be identified.

In direct injection (DI) diesel engines (i.e., engines wherein the fuel is directly injected into the combustion chamber, as opposed to an indirect injection scheme wherein fuel is injected into a pre-chamber opening onto a main combustion chamber adjacent the piston), most present combustion chamber designs can be categorized as either a re-entrant chamber design or an open chamber design. A reentrant design utilizes a piston bowl which curves inwardly from the bowl's top edges toward the sides of the piston to enhance mixing via swirl (preliminary) currents, which are primarily generated from the intake air flow (though squish or secondary currents, which are primarily generated by forcing air off of the piston face into the bowl as the piston face approaches the cylinder head, may also contribute to mixing). An open design lacks such inwardly-extending edges, and instead relies more on fuel spray to provide the desired mixing. Most HSDI (high speed direct ignition) diesel engines, such as automotive engines, achieve the desired degree of mixing by using a small diameter, relatively deep, re-entrant type piston bowl. In contrast, larger heavy-duty engines, which operate at lower speeds (and thus can utilize lower mixing rates), typically use larger diameter, open-type bowls. While fuel spray orientation varies, fuel spray for reentrant bowls is generally oriented towards the bowl lip, where it is pulled into the bowl by swirl currents. In open bowls, the fuel spray is generally oriented towards the bottom surface of the bowl or towards the squish region (the region on the piston face bounding the bowl).

Studies have indicated that re-entrant chamber designs generally result in better fuel economy and lower emissions in HSDI engines. Middlemiss (1978) found that re-entrant designs provide higher mixing rates, thereby allowing retarded injection timings and higher speed operation (Middlemiss, I. D., “Characteristics of the Perkins ‘Squish Lip’ Direct Injection Combustion System”, SAE 780113, 1978). This results in lower soot and NOₓ emissions, with no degradation in fuel economy. Saito et al. (1986) also found that a re-entrant chamber produces shorter ignition delays, lower fuel consumption, and lower soot and NOₓ emissions when used with retarded injection timings (Saito, T., Yasuhiro, D., Uchida, N., Ikeya, N., “Effects of Combustion Chamber Geometry on Diesel Combustion”, SAE 861186, 1986). Later studies have suggested that the use of a centrally-situated cone, frustum, or other raised “crown” within the bowl may also have a beneficial effect on performance and emissions (e.g., Zhang, L., Ueda, T., Takatsuki, T., Yokota, K., “A Study of the Effects of Chamber Geometries on Flame Behavior in a DI Diesel Engine”, SAE 952515, 1995). Other studies suggest that it is necessary to consider injection spray angle and injection timing along with chamber geometry, since these three variables strongly interact to determine engine performance (e.g., De Risi, A., Manieri, D., and Laforgia, D., “A Theoretical Investigation on the Effects of Combustion Chamber Geometry and Engine Speed on Soot and NOx Emissions”, ASME-ICE, vol. 33-1, pp. 51-59, Book No. G1127A, 1999.)

While prior studies have resulted in improvements in engine performance, there is still significant room for improvement in combustion chamber designs which result in reduced emissions with reasonable BSFC (brake specific fuel consumption, i.e., fuel consumption per unit of useful output power).

### SUMMARY OF THE INVENTION

The invention, which is defined by the claims set forth at the end of this document, is directed to methods and apparata which provide piston designs (and therefore combustion chamber designs) which result in significant emissions reduction in HSDI engines while maintaining or reducing BSFC. A piston and combustion chamber in accordance with the invention includes a piston face bounded by a piston side, with a face perimeter region extending inwardly from the piston side and preferably being oriented at least substantially perpendicular to the piston side. An open bowl descends from the face perimeter region, with the bowl including a first depressed region descending from the face perimeter region at a first angle (the first angle being measured with respect to the face perimeter region); a second depressed region descending from the first depressed region at a second angle which is greater (i.e., steeper) than the first angle (the second angle also being measured with respect to the face perimeter region); and a bowl floor extending from the second depressed region, preferably across the center of the piston. The first angle at which the first depressed region descends from the face perimeter region is preferably acute, more preferably less than 30 degrees, whereas the second angle at which the second depressed region is preferably greater than 45 degrees. The face perimeter region is preferably rather large (e.g., occupying 40% or more of the piston face, as measured from a plane perpendicular to the axis of the piston) so as to define a relatively large squish region within the combustion chamber. Additionally, it is also preferred that a re-entrant bowl design be avoided, i.e., the first and second depressed regions do not slope outwardly towards the piston side as they extend downwardly towards the bowl floor.

The piston travels within a cylinder to define the combustion chamber between the piston face and the cylinder head of the cylinder. A fuel injector is situated within the combustion chamber, and is configured to inject a fuel plume along a direction oriented above the bowl floor and below the face perimeter region, more preferably toward the first depressed region and at or adjacent to an intermediate edge defined between the first and second depressed regions.

Simulations and experiments have demonstrated that piston and combustion chamber designs having the foregoing characteristics are able to attain decreased emissions while maintaining or reducing BSFC. Further advantages, features, and objects of the invention will be apparent from the following detailed description of the invention in conjunction with the associated drawings.

### BRIEF DESCRIPTION OF THE DRAWINGS

FIG. 1 is a sectional view of an exemplary combustion chamber 18 showing a particularly preferred configuration for a piston face 104, with the piston 100 being situated within its cylinder (including cylinder walls 10 and cylinder head 12) at top dead center (i.e., with the piston face 104 being shown at its closest distance to the cylinder head 12 during operation), and showing a fuel spray plume 20 being ejected from injector 16.

FIG. 2 illustrates the profile of the preferred configuration for piston face 104 (as also shown in FIG. 1) along a plane coincident with the central axis of the piston 100.

FIG. 3 illustrates the profile of another preferred configuration for a piston face 204 along a plane coincident with the central axis of the piston 200.

FIG. 4 illustrates the profile of another preferred configuration for a piston face 304 along a plane coincident with the central axis of the piston 300.

### DETAILED DESCRIPTION OF THE INVENTION

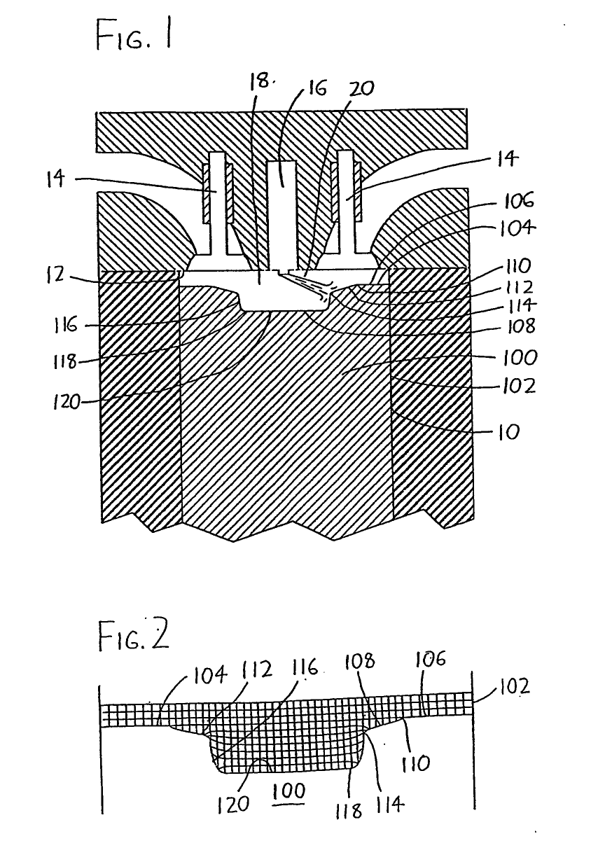

Preferred versions of the piston and combustion chamber designs of the invention will now be described with reference to the piston face configurations of FIGS. 2-4, any of which may be utilized in a diesel engine cylinder and combustion chamber such as the one illustrated in FIG. 1 (which utilizes a piston 100 having the piston face configuration in FIG. 2). The cylinder is defined by cylinder walls 10 along which the piston 100 slides, with the piston having a piston side 102 surrounding a piston face 104. During engine operation, the piston face 104 alternately approaches and retreats from the cylinder head 12, wherein intake and exhaust valves 14 are provided along with an injector 16. The space between the piston face 104, cylinder walls 10, and cylinder head 12 defines the combustion chamber 18 wherein the combustion event occurs after the injector 16 injects a fuel plume 20 into the combustion chamber 18. Note in FIG. 1, the injector 16 is shown injecting one fuel plume 20 into the combustion chamber 18 at an angle (as opposed to along a direction oriented generally coaxially with the axis of the piston 100), though the injector 16 is not shown oriented along this angle (as would usually be the case in practice). Typically, HSDI diesel engine fuel injectors feature multiple spray plumes that originate from 4-10 holes in the injector fuel spray nozzle tip. In this respect, it should be understood that FIG. 1 depicts an exemplary idealized cylinder, and the piston 100 and combustion chamber 18 designs described below may be implemented in engines having cylinder configurations radically different than the one shown.

The following piston 100 and combustion chamber designs are particularly suitable for use in HSDI (high speed direct injection) diesel engines which primarily operate at medium speed and part load, with single injection. HSDI engines may be generally characterized as automotive diesel engines which operate at speeds up to approximately 4500 rpm, and which generally have a 7-10 cm cylinder bore and approximately 0.51 displacement per cylinder; additionally, HSDI engines generally use central injection (i.e., a single multi-hole injector is situated at or about the central axis of the cylinder).

All of the piston designs illustrated in FIGS. 1-4 will now be generally described in terms of their common characteristics, with particular reference being made to the particularly preferred design of FIGS. 1 and 2. The piston face 104 includes a face perimeter region 106 which extends radially inwardly from the surrounding piston side 102, and which is preferably oriented at least substantially perpendicular to the piston side 102 (or more precisely, which is preferably oriented substantially parallel to the overall plane of the opposing surface of the cylinder head 12 so that a squish region of uniform depth is formed about the circumference of the combustion chamber 18). A bowl 108 descends from the face perimeter region 106 at a face region edge 110, and includes a first depressed region 112 descending radially inwardly from the face region edge 110 of the face perimeter region 106 to an intermediate edge 114, a second depressed region 116 descending radially inwardly from the intermediate edge 114 of the first depressed region 112 to a bowl floor edge 118, and a bowl floor 120 which then extends radially inwardly from the second depressed region 116 and bowl floor edge 118 across the center of the piston face 104.

The bowl 108 is of the open type rather than the re-entrant type, i.e., the surfaces between the face perimeter region 106 and the bowl floor 120 do not slope outwardly towards the piston side 102 as they extend downwardly towards the bowl floor 120. The use of an open design rather than a re-entrant design is somewhat uncommon for HSDI engines, but as will be discussed later, the open design appears to generate superior engine performance. The first depressed region 112 descends gently from the face perimeter region 106 at a first angle, and the second depressed region 116 steeply descends from the first depressed region 112 at a greater second angle (with both the first and second angles being measured with respect to a plane perpendicular to the axis of the piston 100). Since the first depressed region 112 need not necessarily take a planar form, i.e., its angle with respect to the face perimeter region 106 may vary along a length of the first depressed region 112 (such length being measured radially from the axis of the piston 100), it is useful to regard the first angle as being measured from the face perimeter region 106 along a line defined between the edges of the first depressed region 112 (i.e., between the face region edge 110 and the intermediate edge 114). Similarly, the second depressed region 116 need not necessarily take a planar form, and it is useful to regard the second angle as being measured from the plane of the face perimeter region 106 along a line defined between the edges of the second depressed region 116 (i.e., between the intermediate edge 114 and the bowl floor edge 118). Preferably, the first depressed region 112 descends from the face perimeter region 106 at an acute first angle of less than 30 degrees, and the second depressed region 116 descends from the first depressed region 112 at a second angle of greater than 45 degrees.

The piston face 102 is also somewhat unusual as compared to most current HSDI engines in that it has a large squish volume (i.e., it has a large volume situated outside the bowl 108 and above the face perimeter region 106 at top dead center). Preferably, the face perimeter region 106 occupies at least 40% of the area of the piston face 104, as measured from projection of the face perimeter region 106 onto a plane perpendicular to the axis of the piston 100. The first depressed region 112, which might be expected to contribute to the squish current effects generated by the face perimeter region 106 since it is only slightly depressed from the face perimeter region 106, also occupies a relatively large portion of the piston face 104. Preferably, it occupies between 15%-30% of the area of the piston face 104, as measured from a projection of the first depressed region 112 onto a plane perpendicular to the axis of the piston 100.

Turning now to a discussion of the specific characteristics of each of the piston and combustion chamber designs of FIGS. 1-4, in the piston face 104 of FIG. 2, the face perimeter region 106 and bowl 108 have approximately the same area (as measured from a projection onto a plane perpendicular to the axis of the piston 100), with the face perimeter region 106 occupying slightly over 50% of the area of the piston face. The first depressed region 112 occupies approximately 25% of the area of the piston face 104, and the bowl floor 120 occupies approximately 15% of the area of the piston face 104, when measured along the same plane. The first depressed region 112 gently descends from the face perimeter region 106 at a first angle of approximately 20 degrees with respect to the face perimeter region 106, and defines approximately 30% of the depth of the bowl 108 (as measured from the plane of the face perimeter region 106 to the plane of the bowl floor 120). The second depressed region 116 steeply descends from the first depressed region 112 at a second angle of approximately 75 degrees with respect to the plane of the face perimeter region 106, and defines approximately 70% of the depth of the bowl 108 (as measured from the plane of the face perimeter region 106 to the plane of the bowl floor 120).

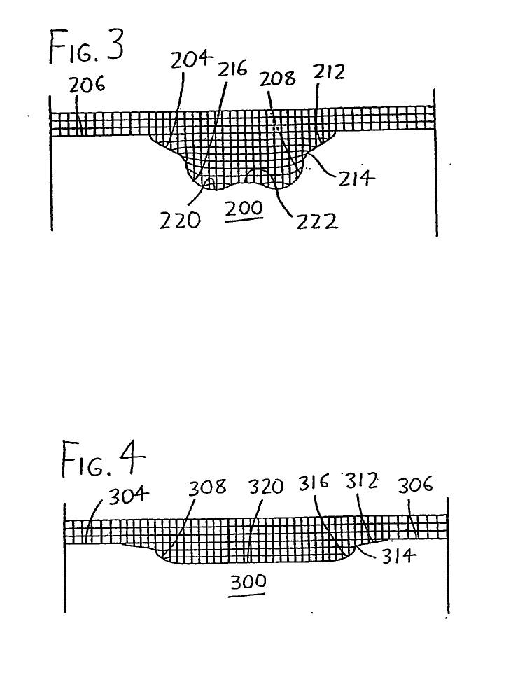

In the piston face 204 of FIG. 3, the face perimeter region 206 is significantly larger than the bowl 208, and occupies approximately 70% of the area of the piston face 204 (as measured from a projection onto a plane perpendicular to the axis of the piston 200). The first depressed region 212 occupies approximately 20% of the area of the piston face 204, and the bowl floor 220 occupies approximately 5% of the area of the piston face 204, when measured along the same plane. The first depressed region 212 gently descends from the face perimeter region 206 at a first angle of approximately 35 degrees with respect to the face perimeter region 206, and defines approximately 40% of the depth of the bowl 208 (as measured from the plane of the face perimeter region 206 to the plane of the bowl floor 220). The second depressed region 216 steeply descends from the first depressed region 212 at a second angle of approximately 50 degrees with respect to the face perimeter region 206, and defines approximately 60% of the depth of the bowl 208 (as measured from the plane of the face perimeter region 206 to the plane of the bowl floor 220). A raised crown 222 is centrally located on the bowl floor 220, but it is relatively low and extends upwardly no further than about 15% of the depth of the bowl 208.

In the piston face 304 of FIG. 4, the face perimeter region 306 is smaller than in the prior embodiments, and occupies slightly over 40% of the area of the piston face 304 (as measured from a projection onto a plane perpendicular to the axis of the piston 300). The first depressed region 312 occupies approximately 25% of the area of the piston face 304, and the bowl floor 320 occupies approximately 20% of the area of the piston face 304, when measured along the same plane. The first depressed region 312 gently descends from the face perimeter region 306 at a first angle of approximately 10 degrees with respect to the face perimeter region 306, and defines approximately 33% of the depth of the bowl 308 (as measured from the plane of the face perimeter region 306 to the plane of the bowl floor 320). The second depressed region 316 steeply descends from the first depressed region 312 at a second angle of approximately 50 degrees with respect to the face perimeter region 306, and defines approximately 66% of the depth of the bowl 308 (as measured from the plane of the face perimeter region 306 to the plane of the bowl floor 320).

The foregoing combustion chamber designs are preferably used with an injector which injects its fuel plumes 20 along a direction oriented above the bowl floors 120, 220, and 320 and below the face perimeter regions 106, 206, and 306, preferably so that the fuel plume 20 is oriented along an axis directed closer to the intermediate edges 114, 214 and 314 than to the bowl floors 120, 220 or 320 or the face perimeter regions 106, 206, or 306. Most preferably, the fuel plume 20 is oriented toward the first depressed regions 112, 212, and 312 and adjacent to the intermediate edges 114, 214 and 314. In simulations, this fuel plume orientation is found to split the fuel vapor between the bowls 108, 208 and 308 and the squish regions situated above the face perimeter regions 106, 206, and 306.

Results from performance simulations of the various piston and combustion chamber configurations of FIGS. 1-4 at medium speed and part load are provided in the accompanying TABLE 1. The piston 100 of FIGS. 1 and 2 resulted in exceptionally low emissions with admirable brake specific fuel consumption. The piston 200 of FIG. 2 had slightly less advantageous (though still good) results, with soot production and BSFC being somewhat higher. The piston 300 of FIG. 3 had the least advantageous performance of the three designs, with exceptionally low soot production but higher NOx and BSFC. Exhaust gas recirculation was used in all cases to attain better emissions. The pistons 100 and 200 demonstrate the characteristics of premixed or Modulated Kinetics (MK) combustion, which (as discussed previously) is known to result in reduced emissions, but which is often difficult to achieve.

TABLE 1
Performance characteristics of designs in FIGS. 1-4

| Parameter | | | |
|---|---|---|---|
| SOI (Start of Injection, crank angle) | +1 | +1 | +13 |
| DOI (Duration of Injection, | 17.88 | 17.88 | 18.77 |
| crank angle) | | | |
| Swirl Ratio | 3.3 | 3.3 | 3.3 |
| % EGR (Exhaust Gas Recirculation) | 19.5 | 15.6 | 19.5 |
| CR (Compression Ratio) | 14.76 | 15.72 | 15.72 |
| Soot (g/kg-fuel) | 0.656 | 1.345 | 0.27 |
| NOx (g/kg-fuel) | 0.696 | 0.693 | 3.89 |
| BSFC (Brake Specific Fuel | 254 | 272 | 352 |
| Consumption, g/kW-hr) | | | |

Further details on the foregoing versions of the invention (and other versions as well) can be found in the paper Wicknan, D. D., Yun, H., Reitz, R. D., “Split-Spray Piston Geometry Optimized for HSDI Diesel Engine Combustion”, SAE 2003-01-0348, 2003, the entirety of which is incorporated by reference herein.

The various preferred versions of the invention are shown and described above to illustrate different possible features of the invention and the varying ways in which these features may be combined. Apart from combining the different features of the different versions in varying ways, other modifications are also considered to be within the scope of the invention. Following is an exemplary list of such modifications.

The piston face profiles depicted in FIGS. 1-4 should be considered representative of piston faces 104, 204, and 304 which are is axially symmetric about the axis of their pistons (i.e., the profiles of FIGS. 1-4, when rotated about their central axes, define the contours of the piston faces 104, 204, and 304). However, it should be understood that the pistons 100, 200, and 300 need not necessarily be axisymmetric; for example, the face perimeter regions, first depressed regions, and second depressed regions need not each have a uniform radial length as they extend about the piston face, and/or sections of the face perimeter regions, first depressed regions, and second depressed regions may have negligible radial length (e.g., the face perimeter region might be formed to extend from at least a substantial portion of the piston side, but may have negligible radial length at certain sections so that the first depressed region extends directly from the piston side).

While the foregoing piston and combustion chamber designs have been described as being particularly suitable for use in HSDI engines, the designs may also be beneficial for use in larger engines (e.g., truck and medium-speed locomotive engines). It is also expected that the designs are also beneficially used at other speeds and loads, and with split (multiple) injections.

The invention is not intended to be limited to the preferred embodiments described above, but rather is intended to be limited only by the claims set out below. Thus, the invention encompasses all alternate embodiments that fall literally or equivalently within the scope of these claims.

1. A diesel combustion chamber comprising:
a. a piston having a piston face bounded by a piston side, wherein the piston face comprises:
(1) a face perimeter region extending radially inwardly from the piston side;
(2) an open bowl descending from the face perimeter region, the bowl including:
i. a first depressed region descending radially inwardly from the face perimeter region at a first angle, the first angle being measured with respect to the face perimeter region;
ii. a second depressed region descending radially inwardly from the first depressed region at a second angle which is greater than the first angle, the second angle being measured with respect to the face perimeter region; and
iii. a bowl floor extending radially inwardly from the second depressed region;
b. a cylinder wherein the piston travels, the cylinder including a cylinder head opposite the piston face, whereby a combustion chamber is defined between the piston face and the cylinder head, and
c. an injector situated within the combustion chamber, the injector being capable of injecting a fuel plume into the combustion chamber;
wherein the injector injects the fuel plume along a direction oriented above the bowl floor and below the face perimeter region.

2. The diesel combustion chamber of claim 1 wherein the first depressed region descends from the face perimeter region at a first angle of less than 30 degrees.

3. The diesel combustion chamber of claim 1 wherein the second depressed region descends from the first depressed region at a second angle of greater than 45 degrees.

4. The diesel combustion chamber of claim 1 wherein the face perimeter region occupies at least 40% of the piston face, as measured from a plane perpendicular to the axis of the piston.

5. The diesel combustion chamber of claim 1 wherein the injector injects the fuel plume along a direction oriented toward the first depressed region and adjacent to the intermediate edge.

6. The diesel combustion chamber of claim 1 wherein the injector injects the fuel plume along a direction oriented toward the intermediate edge.

7. The diesel combustion chamber of claim 1 wherein the piston face is axially symmetric about the axis of the piston.

8. A diesel combustion chamber comprising:
a. a piston having a piston face bounded by a piston side, wherein the piston face comprises:
(1) a face perimeter region extending from at least a substantial portion of the piston side, wherein the face perimeter region is oriented at least substantially perpendicular to the piston side;
(2) a first depressed region gently descending from the face perimeter region at a first angle with respect to the face perimeter region;
(3) a second depressed region steeply descending from the first depressed region at a second angle with respect to the face perimeter region, thereby defining an intermediate edge between the first and second depressed regions; and
(4) a bowl floor extending from the second depressed region and extending across the center of the piston face;
b. a cylinder wherein the piston travels, the cylinder including a cylinder head opposite the piston face, whereby a combustion chamber is defined between the piston face and the cylinder head, and
c. an injector situated within the combustion chamber, the injector being capable of injecting a fuel plume into the combustion chamber;
wherein the injector injects the fuel plume along a direction oriented above the bowl floor and below the face perimeter region.

9. The diesel combustion chamber of claim 8 wherein the surfaces of the first and second depressed regions do not slope outwardly towards the piston side as they extend downwardly towards the bowl floor.

10. The diesel combustion chamber of claim 8 wherein:
a. the first angle is acute; and
b. the second angle is greater than the first angle.

11. The diesel combustion chamber of claim 8 wherein the piston face is axially symmetric about the axis of the piston.

12. The diesel combustion chamber of claim 8 wherein the face perimeter region occupies at least 40% of the piston face, as measured from a plane perpendicular to the axis of the piston.

13. The diesel combustion chamber of claim 8 wherein the first depressed region descends from the face perimeter region at a first angle of less than 30 degrees.

14. The diesel combustion chamber of claim 8 wherein the second depressed region descends from the first depressed region at a second angle of greater than 45 degrees.

15. The diesel combustion chamber of claim 8 wherein the injector injects the fuel plume along a direction oriented closer to the intermediate edge than to the bowl floor or the face perimeter region.

16. The diesel combustion chamber of claim 8 wherein the injector injects the fuel plume along a direction oriented toward the first depressed region.

17. A diesel combustion chamber comprising:
(1) a piston,
(2) a cylinder wherein the piston travels, the cylinder including a cylinder head opposite the piston face, whereby a combustion chamber is defined between the piston face and the cylinder head, and
(3) an injector situated within the combustion chamber, the injector being capable of injecting a fuel plume into the combustion chamber,
wherein the piston includes a piston face bounded by a piston side, the piston face having:
a. a face perimeter region extending inwardly from the piston side;
b. a first depressed region descending from the face perimeter region at a first angle with respect to the face perimeter region;
c. a second depressed region descending from the first depressed region at a second angle with respect to the face perimeter region, the second angle being greater than the first angle; and
d. a bowl floor extending from the second depressed region and extending across the center of the piston,
wherein the injector injects the fuel plume along a direction oriented toward the first depressed region and at or adjacent to the intermediate edge.

18. The diesel combustion chamber of claim 17 wherein the first depressed region, second depressed region, and bowl floor define an open bowl in the piston face.

19. The diesel combustion chamber of claim 17 wherein the surfaces of the first and second depressed regions do not slope outwardly towards the piston side as they extend downwardly towards the bowl floor.
